(19) United States
(12) Patent Application Publication
(10) Pub. No.: US 2026/0149889 A1
(43) Pub. Date: May 28, 2026

(54) DIRECT GENERATION OF GRAY-SCALE IMAGES FROM COLOR PIXEL DATA

(71) Applicant: Zebra Technologies Corporation, Lincolnshire, IL (US)

(72) Inventor: Duanfeng He, South Setauket, NY (US)

(21) Appl. No.: 18/963,682

(22) Filed: Nov. 28, 2024

(51) Int. Cl. H04N 23/84; G06K 7/10; G06K 7/14; H04N 23/12

(52) U.S. Cl. CPC H04N 23/84; H04N 23/12; G06K 2007/10524; G06K 7/1413

(57) ABSTRACT

A method and system for performing grayscale image generation. The method includes obtaining, by a color image sensor, color information of an environment in a field of view of an imaging assembly. The color image sensor includes a plurality of color pixels each configured to obtain respective color information of the environment. Each pixel of the pixel array has a different detection spectrum than adjacent neighboring pixels. A processor determines a grayscale value for each pixel of the plurality of color pixels, the grayscale value determined from color information from a two-by-two array of pixels of the color image sensor. The processor then generates a grayscale image from the grayscale values for each pixel.

### BACKGROUND

Industrial scanners and/or barcode readers may be used in warehouse environments, in point of sale systems, and/or other environments and may be provided in the form of fixed, mountable, or mobile scanning devices, for example. These scanners may be used to scan barcodes and other objects. Due to the widespread use and cost reduction of color imaging sensors, color cameras and sensors are more available and more commonly implemented in such scanners and barcode readers. In many use cases and scenarios, barcodes in color images are not as efficiently decoded, and must be translated to grayscale images before decoding is attempted. Color images contain more information (e.g., color information as an example) and may include additional image details that require additional image processing to identify, and decode barcodes in images. Obtained color images may require additional processing resources and time to perform image processing, and for performing machine vision processes or indicia detection and decoding as compared to grayscale image, or non-color sensor obtained images. Therefore, while the widespread implementation of color image sensor has improved certain functionalities, and enabled certain processes and operations, indicia decoding (e.g., barcode decoding) using color images may be less efficient and less accurate. The result in some color imaging systems for barcode decoding is long, undesirable image processing and decode times, which, may not even result in a successful decode operation.

Accordingly, there is a need for improved designs having improved functionalities.

### SUMMARY

In accordance with a first embodiment, the present invention is a computer-implemented method for performing grayscale image generation. The method includes obtaining, by a color image sensor, color information of an environment in a field of view of an imaging assembly, the color image sensor including a plurality of color pixels each configured to obtain respective color information of the environment; determining, by a processor, a grayscale value for each pixel of the plurality of color pixels, the grayscale value determine from color information from a two-by-two array of pixels of the color image sensor; and generating, by the processor, a grayscale image from the grayscale values for each pixel.

In a variation of the current embodiment, determining the grayscale value for each pixel comprises determining the grayscale value for each given pixel from color information from a neighborhood of pixels relative to the position of each respective given pixel. In continued variations, determining the grayscale value for each given pixel comprises determining the grayscale value from a weighted sum of values of color information from color pixels in relative locations to a respective pixel.

In more variations, the plurality of color pixels includes pixels configured to detect different colors, and wherein the grayscale value for each pixel is determined from a plurality of pixels including at least one pixel of each pixel configured to detect each respective different color. In specific examples, the color image sensor comprises a red-green-blue (RGB) camera with red, green, and blue pixels configured to provide information pertaining to obtained red pixel image values, green pixel image values, and blue pixel image values, and wherein determining the grayscale values comprises determining each grayscale value from at least three pixels in its immediate neighborhood, including one red pixel, one green pixel, and one blue pixel.

In yet more variations, color image sensor comprises pixels in a Bayer pattern. In specific examples, wherein each pixel of the plurality of color pixels is configured to detect a wavelength spectrum than each adjacent color pixel.

In another embodiment, the present invention is an imaging assembly for generating grayscale images from color sensors. The system includes an imaging assembly having a color imaging sensor configured to capture images of an environment in a field of view of the imaging assembly, the color imaging sensor including a plurality of color pixels configured to obtain color information of the environment; one or more processors and machine-readable instructions that when executed by the one or more processors cause the system to: obtain, by the imaging assembly, color information of an environment in a field of view of an imaging assembly; determine, by a processor, a grayscale value for each pixel of the plurality of color pixels, the grayscale value determine from color information from a two-by-two array of pixels of the color image sensor; and generate, by the processor, a grayscale image from the grayscale values for each pixel.

In variations of the current embodiment, to determine the grayscale value for each pixel, the machine-readable instructions cause the system to determine the grayscale value for each given pixel from color information from a neighborhood of pixels relative to the position of each respective given pixel. In more variations, to determine the grayscale value for each given pixel, the machine-readable instructions cause the system to determine the grayscale value from a weighted sum of values of color information from color pixels in relative locations to a respective pixel.

In yet more variations of the current embodiment, the plurality of color pixels includes pixels configured to detect different colors, and wherein the grayscale value for each pixel is determined from a plurality of pixels including at least one pixel of each pixel configured to detect each respective different color.

In even more variations of the current embodiment, each pixel of the plurality of color pixels is configured to detect a wavelength spectrum than each adjacent color pixel. In specific examples, of the current embodiment, the color image sensor comprises a red-green-blue (RGB) camera with red, green, and blue pixels configured to provide information pertaining to obtained red pixel image values, green pixel image values, and blue pixel image values, and wherein determining the grayscale values comprises determining each grayscale value from at least three pixels including one red pixel, one green pixel, and one blue pixel.

In continued variations of the current embodiment, the color image sensor comprises pixels in a Bayer pattern. In specific examples, each pixel of the plurality of color pixels is configured to detect a wavelength spectrum different from each adjacent color pixel.

In yet another embodiment, the present invention is one or more non-transitory computer-readable media storing computer-executable instructions that, when executed via one or more processors, cause one or more systems to: obtain, by a color image sensor, color information of an environment in a field of view of an imaging assembly, the color image sensor including a plurality of color pixels configured to obtain color information of the environment; determine, by a processor, a grayscale value for each pixel of the plurality of color pixels, the grayscale value determine from color information; and generate, by the processor, a grayscale image from the values for each pixel.

In variations of the current embodiment, to determine the grayscale value for each pixel, the computer-executable instructions cause the system to determine, by the processor, the grayscale value for each given pixel from color information from a neighborhood of pixels relative to the position of each respective given pixel. In more variations, to determine the grayscale value for each pixel, the computer-executable instructions cause the system to determine, by the processor, the grayscale value from a weighted sum of values of color information from color pixels in relative locations to a respective pixel.

In further variations of the current embodiment, the color image sensor comprises pixels in a Bayer pattern. In some variations, each pixel of the plurality of color pixels is configured to detect a wavelength spectrum different from each adjacent color pixel. In specific examples, the color image sensor comprises a red-green-blue (RGB) camera with red, green, and blue pixels configured to provide information pertaining to obtained red pixel image values, green pixel image values, and blue pixel image values, and wherein determining the grayscale values comprises determining each grayscale value from at least three pixels including one red pixel, one green pixel, and one blue pixel.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a barcode reader for implementing example methods and/or operations described herein.

FIG. 2 illustrates operation of the barcode reader of FIG. 1 scanning a barcode, in accordance with implementations of the techniques described herein.

FIG. 3 illustrates a block schematic diagram of a portion of the barcode reader of FIG. 1 in accordance with some embodiments described.

FIG. 4 is a block diagram of an example logic circuit for implementing example methods and/or operations described herein.

FIG. 5 is a Bayer filter color sensor array for capturing color images.

FIG. 6 is a flowchart of a method for generating grayscale images from raw color pixel data and values in accordance with some embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Imaging systems for detecting and decoding barcodes often implement color cameras due to their availability, cost, and widespread use and adoption. Sometimes, color sensor cameras are even more affordable and cost effective than black-and-white or grayscale imaging cameras. In many use cases and environments, color images are not as effective in detecting and decoding barcodes as grayscale or black and white images. As such, to improve the functionality of decoding indicia using color images, a method for converting color image data into grayscale data is present. Other method typically convert color images to grayscale for performing further processing, which takes additional processing time and resources and may distort images or lose information in the process. The described method determines grayscale values directly from color sensor data without obtaining intermediate color image values. The described methods improve the efficiency and accuracy of performing identification and decoding of barcodes and indicia using color imaging sensors. The describe methods may be implemented on any imaging system that employs color imaging sensors or cameras, including bioptic scanners, point of sale systems, fixed scanners, slot scanners, and handheld scanners and imagers, among other potential imaging systems.

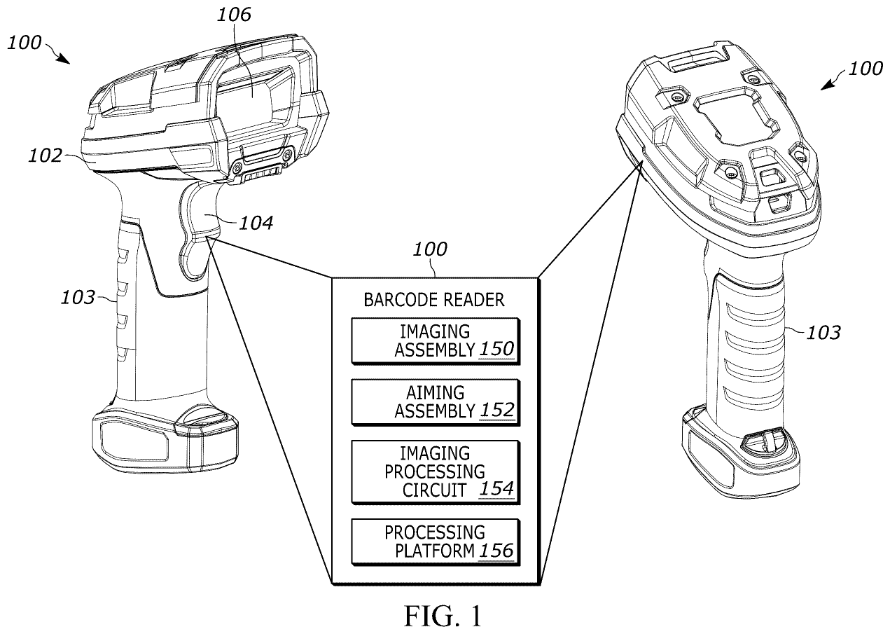

FIG. 1 is an illustration of an example barcode reader 100 capable of implementing operations of the example methods described herein, as may be represented by the flowcharts of the drawings that accompany this description. In the illustrated example, the barcode reader 100 includes a housing 102 with a handle 103 having a trigger 104 on an interior side of the handle. In the illustrated example, the barcode reader 100, enters into a read operation state, by an operator pulling the trigger 104 to scan barcodes. In some examples, the barcode reader 100 is maintained in the read operation state as long as the trigger 104 is depressed, while in other examples the read operation state is entered with a first trigger pull and exited with a subsequent trigger pull.

The housing 102 further includes a scanning window 106 through which the barcode reader 100 illuminates a target such as a packaging, surface, or a pick list for decoding a barcode on the target. As used herein, reference to a barcode includes any indicia that contains decodable information and that may be presented on or within a target, including by not limited to, a one dimension barcode, a two dimension barcode, a three dimension barcode, a four dimension barcode, a QR code, a direct part marking (DPM), a color barcode, a barcode embedded on a color background, another color image with indicia, etc.

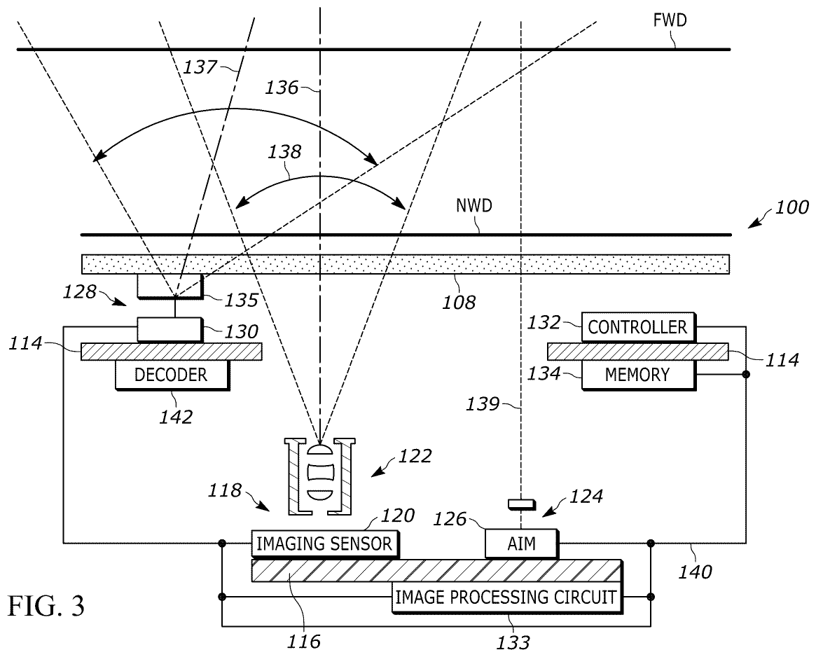

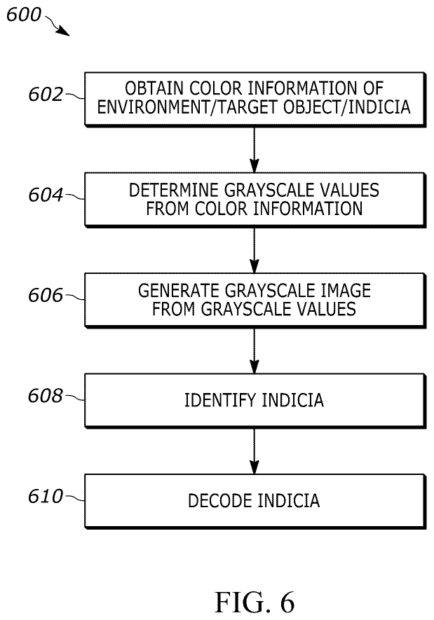

In the illustrated example, the barcode reader 100 includes an imaging assembly 150 configured to capture an image of a target within a predetermined field of view, and in particular, to capture an image that includes a barcode on the target. The barcode reader 100 further includes an aiming assembly 152 configured to generate an aiming pattern, e.g., dot, crosshairs, line, rectangle, circle, etc., that is projected onto the target. The barcode reader 100 further includes image processing circuitry 154 configured to process raw image data provided by the imaging assembly 150 to the image processing circuitry 154. The image processing circuitry 154 may be configured to perform any number of transforms, masks, or other image processing techniques and methods on the raw image data to generate processed image data. Additionally, the image processing circuit 154 may determine not to perform image processing on the raw image data. The barcode reader 100 may further include a processing platform 156 configured to interface with the imaging assembly 150, the aiming assembly 152, the image processing circuitry 154, and other components of the barcode reader 100 to implement operations of the example methods described herein, including those as may be represented by the flowcharts of the drawings such as FIG. 6. In some embodiments, barcode readers described herein may include other elements or systems, such as an illumination assembly for providing monochromatic, white, ultraviolet, or another type of illumination to a target, as described further in reference to FIG. 3.

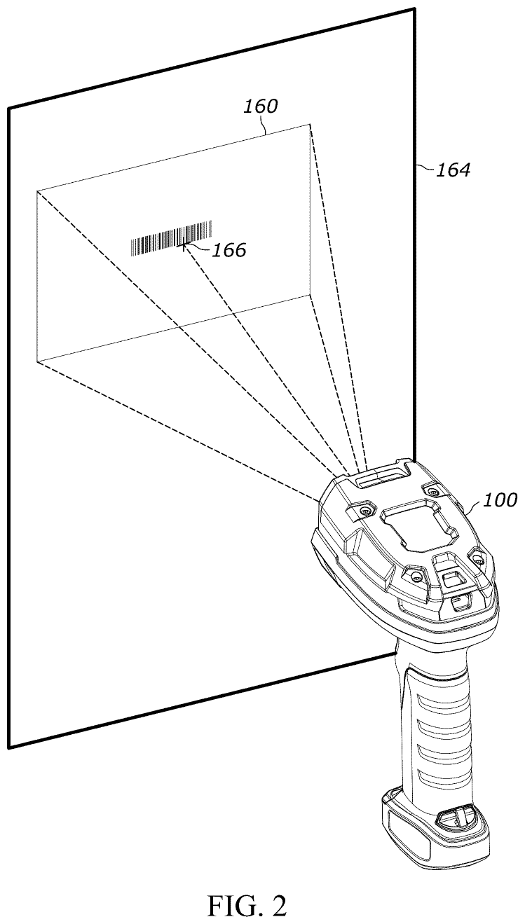

FIG. 2 illustrates operation of the barcode reader 100, in accordance with implementations of the techniques herein. In FIG. 2, the barcode reader 100 is shown in an operational mode having a FOV 160 that sets the bounds for an image environment that may be captured by the imaging apparatus 150. In embodiments, the FOV 160 may be determined by the distance of the barcode reader from a target 164. In the illustrated example, the aiming assembly 152 has generated an aiming pattern 162, which may be a crosshair as shown in FIG. 2. In various embodiments, the aiming pattern 162, may be a dot, multiple dots, multiple crosshairs, or another aiming pattern. In embodiments, the aiming pattern 162, is centered within the FOV 160 and is incident on the target 164 in the center of an environment captured as an image by the barcode reader 100.

In operation, the barcode reader 100 is positioned such that the aiming pattern 162 is incident on a barcode 166, thereby indicating that the barcode 166 is to be decoded, and a decode signal including decoded barcode data, is sent to a remote system. The remote management system may be an inventory management system, payment processing system, theft prevention system, or other network-accessed system or network accessible server.

FIG. 3 illustrates a block schematic diagram of a portion of the barcode reader 100 in accordance with some embodiments. It should be understood that FIG. 3 is not drawn to scale. The barcode reader 100 in FIG. 3 includes: (1) a first circuit board 114; (2) a second circuit board 116; (3) an imaging assembly 118 that includes an imaging sensor 120, and an imaging lens assembly 122; (4) an aiming assembly 124 that includes an aiming light source 126; (5) an illumination assembly 128 that includes an illumination light source 130; (6) a controller 132; (7) an image processing circuit 133; and (8) a memory 134.

The imaging sensor 120 may be either CCD or CMOS imaging sensors that generally include multiple photosensitive pixel elements aligned in a one-dimensional array for linear sensors, or a two-dimensional array for two-dimensional sensors. The imaging sensor 120 is operative to detect light captured by the imaging assembly 118 along an optical path or central field of view (FOV) axis 136 through a window 108. Generally, the image sensor 120 and imaging lens assembly 122 pair is configured to operate together for capturing light scattered, reflected, or emitted from a barcode as pixel data over a one-dimensional or two-dimensional FOV 138 that extends between a near working distance (NWD) and a far working distance (FWD). NWD and FWD denote the distances between which the imaging assembly 118 is designed to read barcodes. In some embodiments, the NDW is between approximately 0 and approximately 2 centimeters from the window 108 and the FWD is between approximately 25 and approximately 150 inches from the window 108. In examples, the imaging sensor 120 may include one or more color imaging cameras, sensors, or detectors. The imaging sensor 120 may include a plurality of color pixels (e.g., image sensors or pixels that detect one or more color band wavelengths of light). The plurality of color pixels may each be designed or configured to detect a respective wavelength or band of wavelengths of light (e.g., color or color spectrum). The plurality of pixels may be disposed in a Bayer pattern, which is described further herein. In specific implementations, the imaging sensor 120 may include an RGB camera with red, green, and blue pixels configured to provide information pertaining to respectively obtained red pixel image values, green pixel image values, and blue pixel image values. Each pixel of the plurality of pixels may further be positioned and configured to detect a different set of colors, or wavelength band than spatially adjacent pixels (e.g., nearest neighbor pixels in horizontal or vertical directions) of the imaging sensor 120.

The imaging sensor 120 is operated by the controller 132, which may be a microprocessor, FPGA, or other processor, that is communicatively connected thereto. Additionally, the controller 132 is communicatively connected to the aiming light source 126, illumination light source 130, image processing circuit 133, and memory 134. Although the link between these components is illustrated as a single communication bus 140, this is merely illustrative, and any communication link between any of the devices may either be dedicated or may include more than the two selected devices. Additionally, placement of components on either side of any of the circuit boards is similarly exemplary. In operation, the memory 134 can be accessible by the controller 132 for storing and retrieving data. In some embodiments, the first circuit board 114 also includes a decoder 142 for decoding one or more barcodes that are captured by the imaging sensor 120. The decoder 142 may be implemented within the controller 132 or as a separate module.

The image processing circuit 133, which may be a microprocessor, FPGA, dedicated image processing unit (IPU), or image signal processor (ISP), may be in communication with the controller 132, and memory 134 for communicating data between the image processing circuit 133 and the controller 132 and/or memory 134. The image processing circuit 133 may be in communication with the imaging sensor 120 such that the imaging sensor 120 may send captured, raw image data to the image processing circuit 133. The image processing circuit 133 may then perform image analysis of the raw image data, and/or perform image processing techniques on the raw image data to generate processed image data. In embodiments, the image processing circuit 133 may output a single set of image data or multiple sets of image data and provide the set or sets of image data to the memory 134 and/or controller 132. The image processing circuit 133 may also provide a set or sets of image data to the decoder 142 for decoding of indicia that may be contained in the image data. In embodiments, the image processing circuit 133 may also determine what type of image data to output. The image processing circuit 133 may make the determination to output raw image data, processed image data, multiple sets of processed image data, or the raw image data and a set or sets of processed image data to the controller 132, memory 134, and/or decoder 142. The raw image data may include raw data from each pixel of a plurality of pixels of the imaging sensor 120. The image processing circuit may then convert the raw data from individual pixels, or pixel groups, into grayscale image values for each respective pixel, as described further herein. In examples, the image processing circuit 133 may perform the conversion to grayscale values before an image has been generated based on the raw data from pluralities of pixels themselves.

In an operation example, the imaging sensor 120 may detect light captured by the imaging assembly 118 in accordance with exposure parameters. The exposure parameters may be based on at least one of ambient illumination level, a distance of an object being captured by the imaging sensor 120, a color of an object being captured by the imaging sensor 120, and a color of a barcode on an object being captured by the imaging sensor 120 wherein the barcode is to be decoded by the decoder 142. Further, the exposure parameters may be a focus of the imaging assembly 118, a white balance correction of the imaging sensor 120, and a level of illumination provided by the illumination light source 130. The exposure parameters may be determined from an auto-exposure region wherein the auto-exposure region is less than one percent of the size of the field of view 138 or less than five percent the size of the field of view 138. The exposure parameters may be stored at the memory 134.

An image captured by the imaging sensor may comprise image property data including a brightness of the image and a contrast of the image. Image property data may be natively output by the imaging sensor 120, or may be determined at the decoder 142, the controller 132, or the image processing circuit 133. In embodiments, the imaging sensor 120 provides the image processing circuit 133 with raw image data, and the image processing circuit 133 performs analysis on the raw image data to determine image property data. The determined image property data may include image contrast data, image spatial frequency content, image chromatic content data, spatial resolution data, image size data, image sharpness data, image brightness data, among other types of image property data. In embodiments, the imaging sensor 120 may have built in circuits and features to determine image property data and to output the image property data to the image processing circuit 133, the controller, 132, and/or the memory 134.

As indicated above, the illumination light source 130 is communicatively connected to the controller 132, and is activated by the controller 132 in response to a user actuating the trigger 110 in a handheld mode of operation. In a hands-free mode of operation, the controller 132 may continuously activate the illumination light source 130. The illumination light source 130 is operative to emit light through the window 108 along an optical path or central illumination axis 137 through the window 108. In an embodiment, the illumination light source 130 is vertically offset from the imaging sensor 120. In another embodiment, in order to avoid directing an intense amount of light at the middle of a barcode and over-saturating the barcode image, the barcode reader has two illumination light sources, each horizontally offset to either side of the imaging sensor 120. In embodiments, the illumination light source 130 may be configured to provide monochromatic light, white, light, ultraviolet light, or light with a band of frequencies or colors for illuminating a target.

As indicated above, the aiming light source 126 is communicatively connected to the controller 132. The aiming light source 126 and aiming assembly 124 are operative to emit light in the form of an aiming pattern through the window 108 along the aiming path or central aiming axis 139, the aiming pattern is defined by the central aiming axis 139. A user of the scanner 100 may use the aiming pattern as a guide bring a barcode into the FOV 138 such that the barcode is captured. In a hands-free mode, the controller 132 may cease activation of the aiming light source 126 immediately subsequent to the capture of an image at the imaging sensor 120. In a handheld mode, the controller may cease activation of the aiming light source 126 in response to activating the trigger 110 such that the aiming pattern does not interfere with image capture. As shown in FIG. 3, the aiming assembly 124 is offset from the imaging assembly 118 resulting in an off-axis configuration of the central aiming axis 139 and the FOV 138 including the central FOV axis 136.

In the embodiment illustrated in FIG. 3, the illumination light source 130 is provided on the first circuit board 114, whereas the imaging sensor 120 is provided on the second circuit board 116. However, in some embodiments, the illumination light source 130 and the imaging sensor 120 are provided on the same circuit board. The optical element 135 may be any optical element that redirects light emitted by the illumination light source 130, and, more particularly, redirects the central illumination axis 137 of the illumination light source 130 with little to no magnification of the light. In some embodiments, the optical element 135 is a prism, such as a deflecting prism, though the optical element 135 may also be a mirror, a series of mirrors, optical waveguide(s), etc. Where the optical element 135 is an optical waveguide, it will be understood that an optical waveguide restricts the spatial range in which the light can propagate using a region having an increased refractive index as compared to the surrounding medium. Examples of suitable optical waveguides include, but are not limited to, single mode optical fiber, channel waveguides, planar waveguides, and strip waveguides. Preferably, the optical element does not magnify, or only minimally magnifies, the illumination light from the illumination light source 130 in order to avoid specular reflections off the barcode.

In an embodiment, the optical element 135 is adhered, or otherwise affixed, to the window 108. In a different embodiment, the window 108 may be molded such that the optical element 135 is integral with the window 108. In yet another embodiment in which the barcode reader 100 has two illumination sources, an optical element 135 may be provided for each illumination light source. In a different embodiment in which the barcode reader 100 has two illumination light sources, the optical elements 135 may be integral with one another, such as a single prism extending in width to each of the illumination light sources.

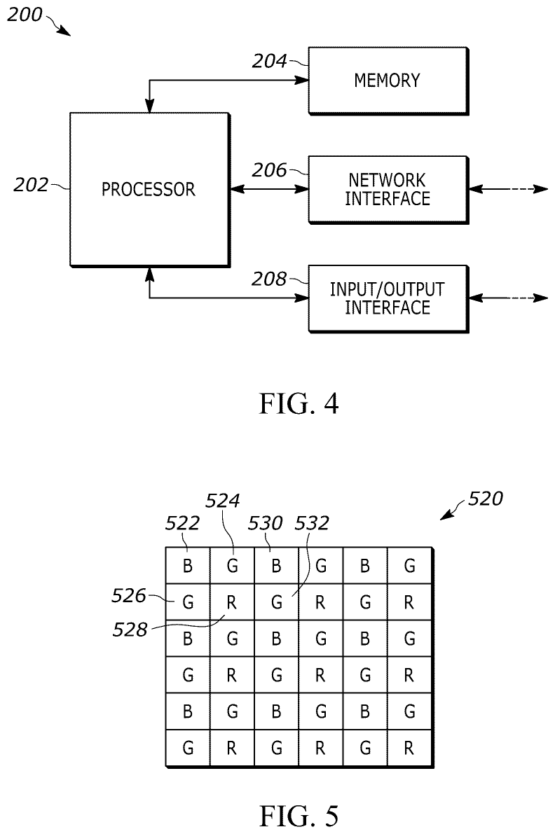

FIG. 4 is a block diagram representative of an example logic circuit capable of implementing, for example, one or more components of the example barcode reader 100 of FIG. 1 for performing grayscale conversion of color sensor data and generating grayscale images. The example logic circuit of FIG. 4 is a processing platform 200 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 200 of FIG. 4 includes a processor 202 such as, for example, one or more microprocessors, controllers, and/or any suitable type of processor. The example processing platform 200 of FIG. 4 includes memory (e.g., volatile memory, non-volatile memory) 204 accessible by the processor 202 (e.g., via a memory controller). The example processor 202 interacts with the memory 204 to obtain, for example, machine-readable instructions stored in the memory 204 corresponding to, for example, the operations represented by the flowcharts of this disclosure. Additionally or alternatively, machine-readable instructions corresponding to the example operations described herein may be stored on one or more removable media (e.g., a compact disc, a digital versatile disc, removable flash memory, etc.) that may be coupled to the processing platform 200 to provide access to the machine-readable instructions stored thereon.

The example processing platform 200 of FIG. 4 also includes a network interface 206 to enable communication with other machines via, for example, one or more networks. The example network interface 206 includes any suitable type of communication interface(s) (e.g., wired and/or wireless interfaces) configured to operate in accordance with any suitable protocol(s).

The example, processing platform 200 of FIG. 4 also includes input/output (I/O) interfaces 208 to enable receipt of user input and communication of output data to the user.

The processor 202 may be configured to perform functions performed by elements described in reference to FIG. 3, and more specifically the processor 202 may execute machine readable instructions to perform functions of the image processing circuit 313, the controller 132, and the decoder 142.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

FIG. 5 is a Bayer filter color sensor array 520 for capturing color images. The Bayer color sensor array 520 has three different color sensors, red sensors denoted by the letter “R”, green sensors denoted by the letter “G”, and blue sensor denoted by the letter “B”, configured in a six-by-six spatial pattern. The different pixel types (i.e., red, green and blue) each detects a different color or wavelength band to generate color pixel information. Each pixel of the Bayer color sensor array 520 is disposed next to adjacent pixels of different types that are configured to detect different colors. For example, each blue pixel's nearest neighbor both vertically and horizontally are green pixels, and each green pixel has nearest neighbor blue pixels horizontally, and red pixels vertically. As such, each given pixel's nearest neighbors vertically and horizontally are configured to detect a different set of wavelengths than the given pixel's active wavelength detection band. The Bayer color sensor array 520, also referred to as a Bayer sensor array, is one example of a color sensor array for obtaining color image data for performing the methods and techniques described herein. Other color sensor types and arrays are envisioned.

FIG. 6 is a flow diagram of an embodiment of a process 600 for generating grayscale images from color information obtained by one or more color sensors as may be performed by the barcode reader 100 of FIGS. 1-3. Initially, at a process 602 the barcode reader 100 obtains color information of an environment in a field of view of the barcode reader 100. One or more color image sensors including a plurality of color sensor pixels (e.g., in a pixel array such as the example Bayer pixel array 520 of FIG. 5) obtained the color information of the environment. Each color pixel of the one or more color image sensors is configured to detect a specific color or wavelength band of light. For example, some of the pixels may be generally configured to detect green light, blue light, red light, or another color of light from the environment. The color pixels may be configured to detect the specific colors or wavelength band via one or more color filters, or by a specific detection wavelength efficiency band with greater detection efficiencies at the desired wavelength band, and lower efficiencies at undesirable wavelength bands or colors for a given pixel sensor.

A processor then determines grayscale values from the obtained color information, at a process 604. The grayscale values are determined for each color pixel of the pixel sensor array. In examples, the grayscale value for a given pixel may be determined from the color information and values of a neighborhood of pixels adjacent to, or in the physical region of the given pixel. For example, the grayscale value for a target pixel may be determined by a weighted sum of the color values from neighboring pixels in a two-by-two neighborhood including the target pixel. EQ. 1 is an example of determining the grayscale value for a pixel from a neighborhood of two-by-two color pixel values.

$$Y = a R + b G + c B \qquad EQ . 1$$

Using EQ. 1, the grayscale value, Y, is determined from the color pixels for a neighboring red pixel value, R, a neighboring blue pixel value, B, and a neighboring green pixel, G, with corresponding weighted constant values a, b, and c. In examples, the grayscale pixel value may be determined from more than one red pixel value, more than one blue pixel value, and/or more than one green pixel value depending on the position of the target pixel and corresponding neighboring pixel color types.

In examples, the red, green, and blue (RGB) color pixel values may range from 0 to 255, and the constants a, b, and c, may be normalized or determined based on the possible values of the RGB pixel values. Additionally, the weighted values may be determined based on a brightness perceived by the human eye or sensitivity of the human eye to various wavelength bands. The weight values may further be determined to increase the influence of certain wavelength bands, while reducing the impact of other wavelength bands in generating the grayscale value.

The Bayer pattern sensor array 520 of FIG. 5 will be referenced to illustrate an example of performing the methods of generating grayscale images described herein. In an example, the processor may determine a grayscale value for a first pixel 522 from a two-by-two set of pixels. The two-by-two neighborhood for determining the grayscale value for the first pixel 522 may include a green color value from a second pixel 524 horizontally adjacent to the first pixel 522, a green color value from a third pixel 526 vertically adjacent (e.g., below) the first pixel 522, a red color value from a fourth pixel 528 diagonal to the first pixel 522, and may also include a blue color value from the first pixel 522. In a specific example, the constants a, b, and c, in EQ. 1 may take on values of 0.299, 0.587, and 0.114 and EQ. 1 becomes

$$Y = 0.299 R + 0.587 ( G 1 + G 2 ) + 0.114 B \qquad EQ . 2$$

where G1 is a green pixel value from the second pixel 524 and G2 is a green pixel value from the third pixel 526. In the example of the Bayer pixel array pattern 250 of FIG. 5, EQ. 1 will always include two green pixels when using a two-by-two matrix array of pixels for determining the grayscale value. The grayscale value for a given pixel is then determined from the color value of the target pixel itself, the color values from two adjacent pixels (i.e., horizontal and vertically adjacent second and third pixels 524 and 526), and the color value from one diagonally position pixel (i.e., fourth pixel 528). A grayscale value for the second pixel 524 may then be determined using the color value from the second pixel 524, a blue color value from a horizontally adjacent fifth pixel 530, a red color value from the vertically adjacent fourth pixel 528, and a green color value from a diagonally positioned sixth pixel 532. The processor may then iteratively determine grayscale values for each pixel of the Bayer pixel array 520 using two-by-two neighborhoods of color pixels. It should be noted, in the current example, pixels at the far right column, and bottom row may use a different method for determining the grayscale value, or a grayscale value may not be determined for these pixels reducing a resulting grayscale image by one row and one column due to a lack of a corresponding two-by-two neighborhood for such pixels. The grayscale value for the far right column and bottom row may further be determined to be equal to an adjacent column or row to maintain image size. It should be understood that the example described herein may be performed using another size array of neighboring pixels, and that EQ. 1 would be appropriately modified given a desired size of the neighborhood array. Additionally, it should be understood that the color pixel values are determined from the raw color data received from each individual pixel or sensor in a pixel array.

At a process 606, the processor generates a grayscale image from the set of grayscale values determined for the pixel array. To generate the grayscale image, the processor generates the image using the resultant grayscale values and positions of corresponding pixels in the pixel array. The process 600 further includes identifying an indicia in the generated grayscale image at a process 608. The processor may identify the indicia using any number of image processing techniques including preprocessing which may include image sharpening, geometric transformations, rotations, skewing, brightness filters, high or low frequency filtering, or another image processing technique. The processor may use a template or be configured to identify one or more types of indicia including, without limitation, a 1D barcode, a QR code, a data matrix code, or another type of indicia.

At a process 610, the process decodes the indicia in the grayscale image, and identifies a payload associated with one or more objects in the environment or field of view of the barcode reader 100. Decoding of the indicia in the grayscale image may be performed with higher accuracy than performing identification and decoding of indicia in a color image. Further, the methods of converting raw color data into grayscale data for each pixel, and then generating a grayscale image from the pixel grayscale data is more efficient, and more accurate, in generating a grayscale image than other methods that generate color images, and subsequently convert the color images to grayscale images. The described systems and methods for generating grayscale images from raw color pixel data provide improvements in efficiency and accuracy over other systems that implement color cameras for identify and decode indicia, such as barcodes.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

We claim:

1. A computer-implemented method for performing grayscale image generation, the method comprising:
obtaining, by a color image sensor, color information of an environment in a field of view of an imaging assembly, the color image sensor including a plurality of color pixels each configured to obtain respective color information of the environment;
determining, by a processor, a grayscale value for each pixel of the plurality of color pixels, the grayscale value determine from color information from a two-by-two array of pixels of the color image sensor; and
generating, by the processor, a grayscale image from the grayscale values for each pixel.

2. The method of claim 1, wherein determining the grayscale value for each pixel comprises determining the grayscale value for each given pixel from color information from a neighborhood of pixels relative to a position of each respective given pixel.

3. The method of claim 1, wherein the plurality of color pixels includes pixels configured to detect different colors, and wherein the grayscale value for each pixel is determined from a plurality of pixels including at least one pixel of each pixel configured to detect each respective different color.

4. The method of claim 1, wherein determining the grayscale value for each given pixel comprises determining the grayscale value from a weighted sum of values of color information from color pixels in relative locations to a respective pixel.

5. The method of claim 1, wherein the color image sensor comprises pixels in a Bayer pattern.

6. The method of claim 1, wherein the color image sensor comprises a red-green-blue (RGB) camera with red, green, and blue pixels configured to provide information pertaining to obtained red pixel image values, green pixel image values, and blue pixel image values, and wherein determining the grayscale values comprises determining each grayscale value from at least three pixels including one red pixel, one green pixel, and one blue pixel.

7. The method of claim 1, wherein each pixel of the plurality of color pixels is configured to detect a wavelength spectrum different than each adjacent color pixel.

8. A system for generating grayscale images from color sensors, the system comprising:
an imaging assembly having a color imaging sensor configured to capture images of an environment in a field of view of the imaging assembly, the color imaging sensor including a plurality of color pixels configured to obtain color information of the environment; and
one or more processors and machine-readable instructions that when executed by the one or more processors cause the system to:
obtain, by the imaging assembly, color information of an environment in a field of view of an imaging assembly;
determine, by a processor, a grayscale value for each pixel of the plurality of color pixels, the grayscale value determine from color information from a two-by-two array of pixels of the color image sensor; and
generate, by the processor, a grayscale image from the grayscale values for each pixel.

9. The system of claim 8, wherein to determine the grayscale value for each pixel, the machine-readable instructions cause the system to determine the grayscale value for each given pixel from color information from a neighborhood of pixels relative to a position of each respective given pixel.

10. The system of claim 8, wherein the plurality of color pixels includes pixels configured to detect different colors, and wherein the grayscale value for each pixel is determined from a plurality of pixels including at least one pixel of each pixel configured to detect each respective different color.

11. The system of claim 8, wherein to determine the grayscale value for each given pixel, the machine-readable instructions cause the system to determine the grayscale value from a weighted sum of values of color information from color pixels in relative locations to a respective pixel.

12. The system of claim 8, wherein the color image sensor comprises pixels in a Bayer pattern.

13. The system of claim 8, wherein the color image sensor comprises a red-green-blue (RGB) camera with red, green, and blue pixels configured to provide information pertaining to obtained red pixel image values, green pixel image values, and blue pixel image values, and wherein determining the grayscale values comprises determining each grayscale value from at least three pixels including one red pixel, one green pixel, and one blue pixel.

14. The system of claim 8, wherein each pixel of the plurality of color pixels is configured to detect a wavelength spectrum different than each adjacent color pixel.

15. One or more non-transitory computer-readable media storing computer-executable instructions that, when executed via one or more processors, cause one or more systems to:
obtaining, by a color image sensor, color information of an environment in a field of view of an imaging assembly, the color image sensor including a plurality of color pixels configured to obtain color information of the environment;
determining, by a processor, a grayscale value for each pixel of the plurality of color pixels, the grayscale value determine from color information; and
generating, by the processor, a grayscale image from the grayscale values for each pixel.

16. The computer-readable media of claim 15, wherein determining the grayscale value for each pixel comprises determining, by the processor, the grayscale value for each given pixel from color information from a neighborhood of pixels relative to a position of each respective given pixel.

17. The computer-readable media of claim 15, wherein determining the grayscale value for each given pixel comprises determining, by the processor, the grayscale value from a weighted sum of values of color information from color pixels in relative locations to a respective pixel.

18. The computer-readable media of claim 15, wherein the color image sensor comprises pixels in a Bayer pattern.

19. The computer-readable media of claim 15, wherein the color image sensor comprises a red-green-blue (RGB) camera with red, green, and blue pixels configured to provide information pertaining to obtained red pixel image values, green pixel image values, and blue pixel image values, and wherein determining the grayscale values comprises determining each grayscale value from at least three pixels including one red pixel, one green pixel, and one blue pixel.

20. The computer-readable media of claim 15, wherein each pixel of the plurality of color pixels is configured to detect a wavelength spectrum different than each adjacent color pixel.
